(19) United States
(12) Patent Application Publication
(10) Pub. No.: US 2005/0284245 A1
(43) Pub. Date: Dec. 29, 2005

(54) Integrated design system of electric power steering system

(76) Inventors: Hui Chen, Gunma (JP); Yushin Ma, Gunma (JP)

Correspondence Address: SUGHRUE MION, PLLC, 2100 PENNSYLVANIA AVENUE, N.W., SUITE 800, WASHINGTON, DC, 20037, US

(21) Appl. No.: 10/536,991

(22) PCT Filed: Nov. 11, 2003
(86) PCT No.: PCT/JP03/14332

§ 371 Date: May 31, 2005

(30) Foreign Application Priority Data
Nov. 28, 2002 (JP) 2002-344838

(51) Int. Cl. F16H 35/00

(52) U.S. Cl. 74/388 PS

(57) ABSTRACT

An integrated design system of an electric power steering apparatus in which a steering assisting force is given to a steering mechanism based on a current control value calculated from a motor current value detected by a motor current detection means, and a steering auxiliary command value calculated by a calculation means based on a steering torque and a vehicle speed, comprises a simulation controller for connecting an analysis tool of control system, an analysis tool of motor electromagnetic field and an analysis tool of mechanism of vehicle through an interface, and carrying out integrated simulation of said electric power steering apparatus.

### TECHNICAL FIELD

The present invention relates to an integrated design system of an electric power steering apparatus for simulating an electric power steering apparatus in which a steering assisting force caused by a motor is given to a steering system of an automobile or a vehicle by using a computer, and for efficiently and swiftly designing the electric power steering apparatus.

### BACKGROUND TECHNIQUE

An electric power steering apparatus applies an auxiliary load to a steering system of an automobile or a vehicle using a rotation force of a motor. Such an electric power steering apparatus applies a driving force of the motor, i.e., the auxiliary load to a steering shaft or a rack shaft by means of a transmitting mechanism such as a gear or a belt through a speed reducer. To precisely generate an assist torque (steering auxiliary torque), such an electric power steering apparatus carries out feedback control of motor current. The feedback control adjusts voltage to be applied to the motor such that a difference between a current control value and a motor current detection value becomes small. Generally, the voltage to be applied to the motor is adjusted by adjusting a duty ratio of PWM (pulse-width modulation) control.

Here, a general structure of the electric power steering apparatus will be explained with reference to FIG. 1. A shaft 2 of a steering wheel 1 is connected to tie rod 6 of running wheels through a reduction gear 3, universal joints 4a and 4b and a pinion rack mechanism 5. The shaft 2 is provided with a torque sensor 10 which detects a steering torque of the steering wheel 1. A motor 20 which assists a steering force of the steering wheel 1 is connected to the shaft 2 through the reduction gear 3. Electricity is supplied to a control unit 30 which controls a power steering system from a battery 14 through an ignition key 11 and a power supply relay 13. The control unit 30 calculates a steering auxiliary command value I of an assist command based on a steering torque T detected by a torque sensor 10 and a vehicle speed V detected by a vehicle speed sensor 12, and controls current to be supplied to the motor 20 based on the calculated steering auxiliary command value I.

The control unit 30 mainly is comprised of a CPU. General functions carried out by program in the CPU are as shown in FIG. 2. For example, a phase compensator 31 is not a phase compensator as independent hardware, but is a phase compensating function carried out by the CPU.

The functions and operation of the control unit (ECU) 30 will be explained. A steering torque T which is detected by the torque sensor 10 and is input is compensated in phase by a phase compensator 31 so as to enhance the stability of a steering system, and the phase-compensated steering torque TA is input to a steering auxiliary command calculator 32. A vehicle speed V detected by the vehicle speed sensor 12 is also input to the steering auxiliary command calculator 32. The steering auxiliary command calculator 32 calculates a steering auxiliary command value I which is a control target value of current to be supplied to the motor 20 based on the input steering torque TA and the vehicle speed V. The steering auxiliary command value I is input to a subtracter 30A, and is also input to a feedforward differentiation compensator 34 to enhance the response speed. A deviation (I-i) of the subtracter 30A is input to a proportion calculator 35, its proportion output is input to an adder 30B, and is also input to an integration calculator 36 to enhance the characteristics of the feedback system. Outputs of the differentiation compensator 34 and the integration calculator 36 are also added and input to the adder 30B, and a current control value E which is a result of addition in the adder 30B is input to a motor drive circuit 37 as a motor drive signal. A motor current value i of the motor 20 is detected by a motor current detection means 38, and the detected motor current value i is input to the subtracter 30A and is fed back.

Conventionally, such an electric power steering apparatus (EPS) is to be designed in a manner shown in FIG. 3. That is, in a manufacturing enterprise of the electric power steering apparatus (part maker), using a personal computer carries out the system design, and a prototype of the electric power steering apparatus is manufactured. The manufactured prototype is subjected to a HIL (Hardware in the Loop) test or bench simulator, and evaluation of the electric power steering apparatus and parameter calibration are carried out, and after the final adjustment, the electric power steering apparatus is supplied to an automobile maker as a product. The HIL test is a means for evaluating performance or quality of the ECU by connecting to the hardware and virtual system (portions other than the EUC including an automobile). The bench simulator is an apparatus for evaluating performance or quality of the system constituted by products (ECU, motor, steering gear and the like) and pseudo-part (automobile) other than the products.

When the electric power steering apparatus is supplied to the automobile maker, the manufacturing enterprise of the electric power steering apparatus sends control program and tuning parameter to the automobile maker via E-mail. Data sent from a part maker to the automobile maker includes an executive file of the ECU (e.g., executive file of “.mot”) and a tuning parameter file (e.g., C language file such as “.c”).

In the automobile maker, the supplied electric power steering apparatus is tuned by a CAN (Control Area Network) using the sent control program and the tuning parameter, and determines calibration data suitable for an automobile on which the electric power steering apparatus is mounted by repeating the tuning operation. The finally adjusted electric power steering apparatus is mounted on the automobile, and the corresponding data is fed back to the manufacturing enterprise of the electric power steering apparatus (part maker) via E-mail or the like. The manufacturing enterprise of the electric power steering apparatus that received the calibration data repeats the designing operation of the system based on the data sent from the automobile maker, and tries to complete a better product.

In the above-described designing and manufacturing styles, conventionally, software for enhancing the efficiency of the system design has been developed and is widely used. Software as shown in FIG. 4 is used for supporting the designing operation of a control system, and software as shown in FIG. 5 is used for supporting the designing operation of a mechanical system. That is, support software for supporting the designing of the control system such as Matlab/Simulink (trademark) and JMAG (trademark) are available commercially. As shown in FIG. 4, a torque command (current command) is given (step S10) to control the motor (step S11), current output from the motor is detected (step S12), and the motor is analyzed based on this output (step S13). Torque and voltage are calculated by analyzing the motor (step S14), and the torque and the voltage are fed back to the motor control. Step S13 and step S14 are calculated by JMAG, and other steps are calculated by Matlab/Simulink, and the exchange of data is performed through an interface (S-Function). Such support software makes the design of the motor control easy.

Support software for supporting the designing of the mechanical system such as ADAMS (trademark) is available commercially. As shown in FIG. 5, a steering angle (a steering torque) is given (step S20) to perform the electric power steering control (step S21), the mechanical system of the electric power steering is driven (step S22), and a vehicle is allowed to run based on its output (step S23). Characteristics obtained by the running of the vehicle are fed back to the control of the electric power steering. Such support software makes the designing of the mechanical system control easy.

As described above, in the conventional designing operation for the development of the electric power steering, the speeding up of development is realized by support software for the control system and support software for the mechanical system. However, there is no appearance of measures that integrate support software for the control system and support software for the mechanical system as a whole. Thus, the control system and the mechanical system must be developed separately.

Before a sub-system of product (ECU+motor+mechanism) and a vehicle are combined with each other, it is necessary to carry out analysis for the sub-system of product and a vehicle system including the sub-system of product, discussion about the optimization of the designing operation, and previously evaluation of function, performance and the like. For example, a problem as to how the inertial of the motor exert an effect on the steering performance is related to design of the motor, the control system and the electric power steering mechanism, and characteristics of the vehicle. Thus, a design support system that is capable of analyzing and evaluating the sub-system and the entire system is required.

The present invention has been accomplished in view of the above circumstances, and it is an object of the invention to provide an integrated design system of an electric power steering apparatus which is capable of efficiently and swiftly designing an electric power steering apparatus by integrating support software for a control system and support software for a mechanical system used in development of the electric power steering.

### DISCLOSURE OF THE INVENTION

The present invention relates to an integrated design system of an electric power steering apparatus in which a steering assisting force is given to a steering mechanism based on a current control value calculated from a motor current value detected by a motor current detection means, and a steering auxiliary command value calculated by a calculation means based on a steering torque and a vehicle speed. The above object of the invention is achieved by the following configuration. That is, a simulation controller connects an analysis tool of control system, an analysis tool of motor electromagnetic field and an analysis tool of mechanism of vehicle through an interface, and carry out integrated simulation of said electric power steering apparatus.

Also, the above object of the invention is achieved by the following configuration. That is, said simulation controller controls and manages entire sequence by calling sub-routines through said interface, or said interface converts formats of said analysis tool of control system, said analysis tool of motor electromagnetic field and said analysis tool of mechanism of vehicle into a same format.

### BRIEF DESCRIPTION OF THE DRAWINGS

FIG. 1 is a diagram showing one example of an electric power steering apparatus;

FIG. 2 is a block diagram showing a general internal structure of a control unit;

FIG. 3 is a diagram used for explaining a conventional development environment of an electric power steering apparatus;

FIG. 4 is a flowchart used for explaining a development tool of a control system;

FIG. 5 is a flowchart used for explaining a development tool of a mechanical system;

FIG. 6 is a block diagram used for explaining a principle of the present invention; and

FIG. 7 is a flowchart showing an example of the operation of the invention.

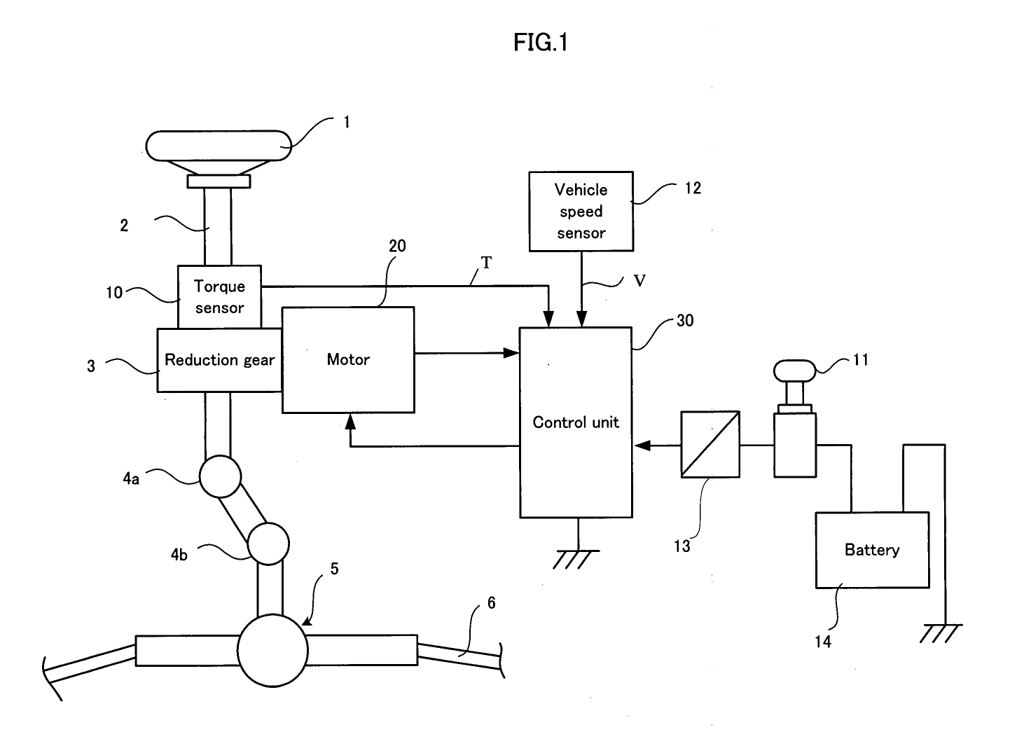

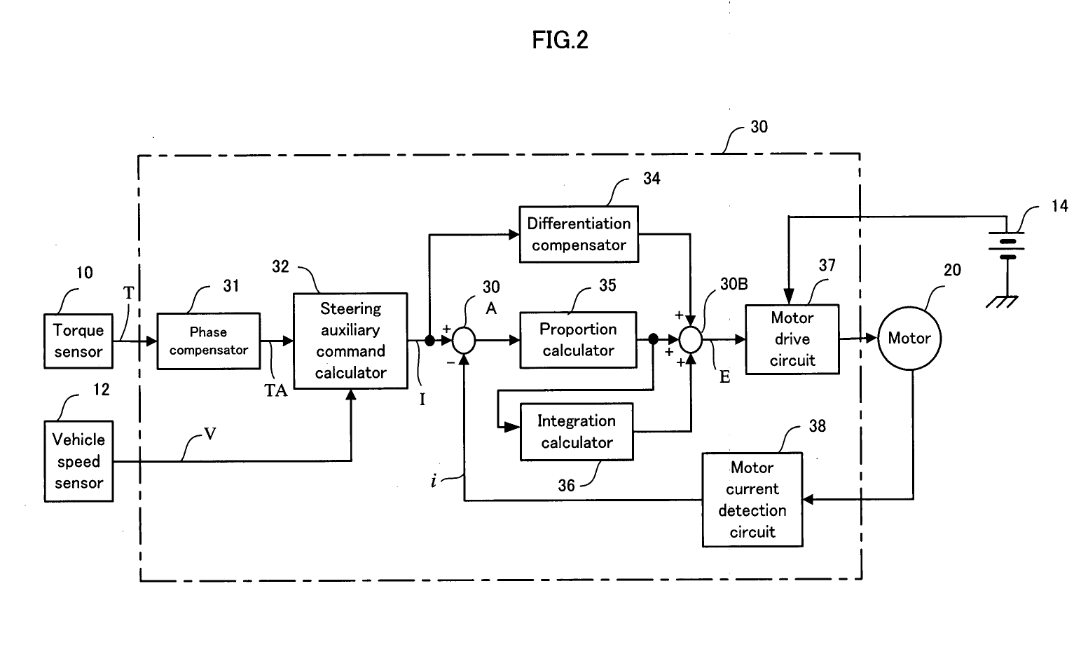

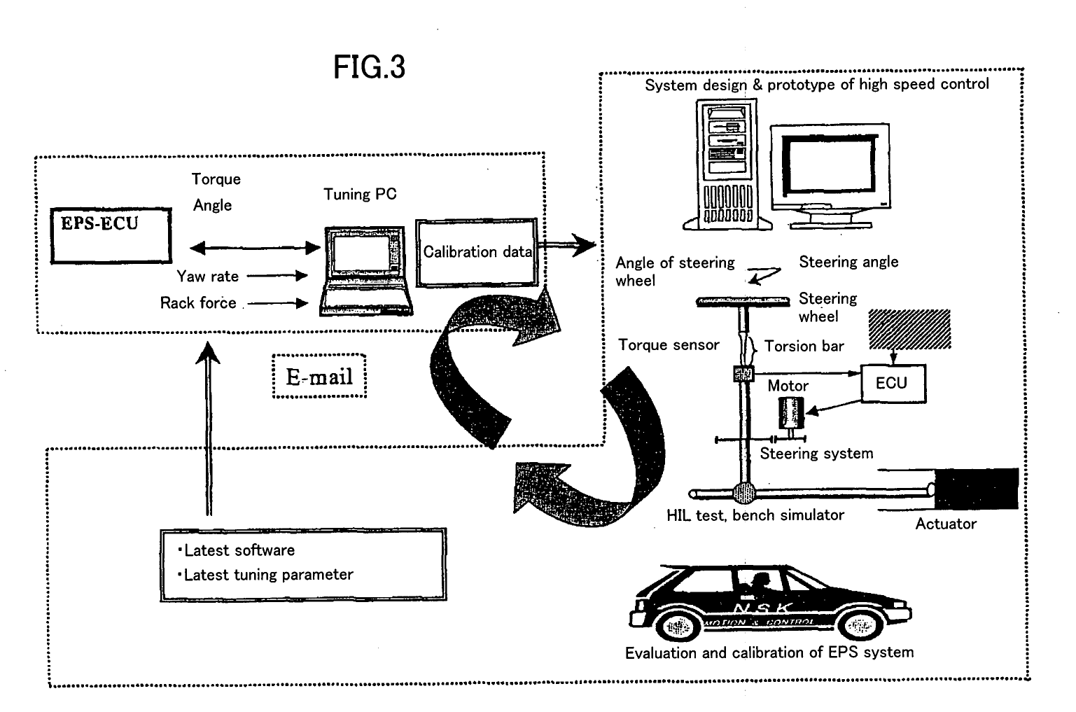

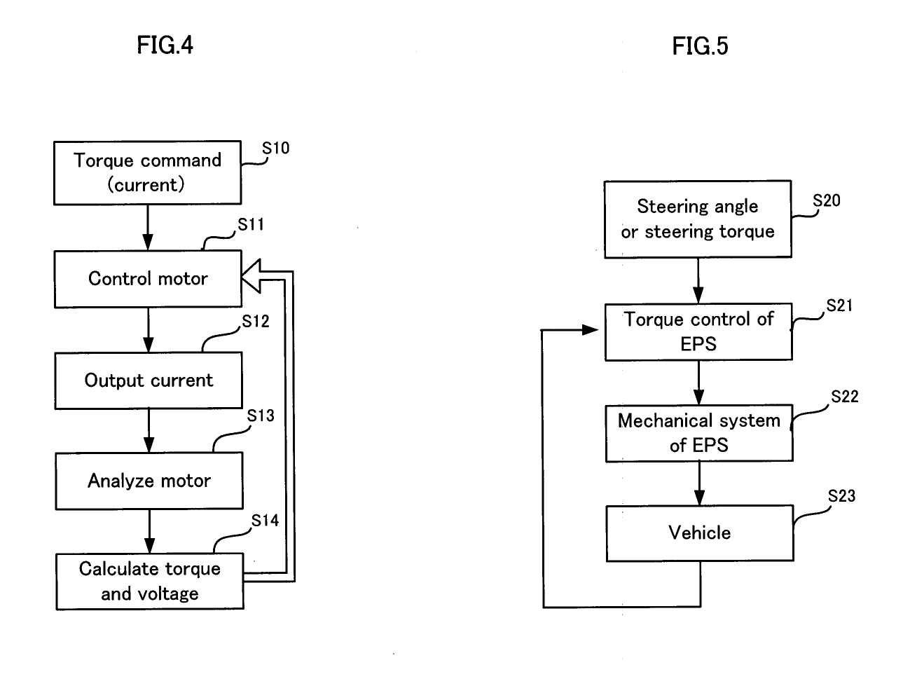

### BEST MODE FOR CARRYING OUT THE INVENTION

According to the present invention, when an electric power steering apparatus is to be developed, an analysis tool of control system, an analysis tool of motor electromagnetic field and an analysis tool of mechanism of vehicle are integrated in terms of software, thereby facilitating the designing operation of the electric power steering apparatus, enhancing the efficiency of the designing operation, and realizing swift development of the electric power steering apparatus.

An embodiment of the invention will be explained with reference to the drawings.

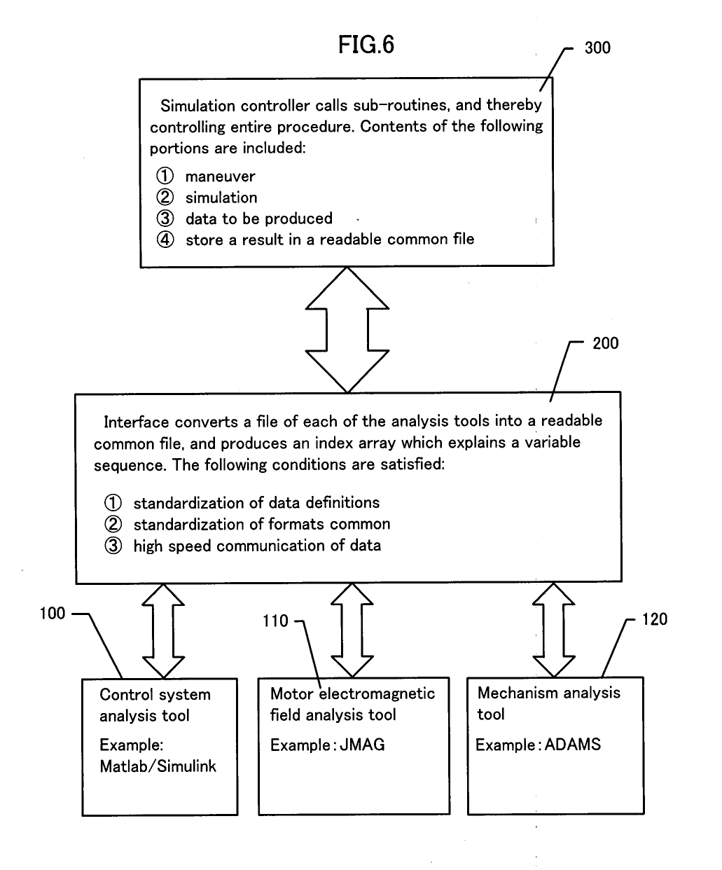

FIG. 6 shows a principle structure of the present invention. As shown in FIG. 6, a simulation controller 300 of an integrated design system controls the entire procedure by calling sub-routines. The simulation controller 300 includes four contents, i.e., (1) maneuver, (2) simulation, (3) data to be produced, and (4) storing a result in a readable common file. An interface 200 is connected to the simulation controller 300. A control system analysis tool 100, a motor electromagnetic field analysis tool 110 and a mechanism analysis tool 120 are connected to the interface 200. The interface 200 converts a file of each analysis tools into a readable common file, and produces an index array which explains a variable sequence. The interface 200 mainly has functions of (1) standardization of data definitions, (2) standardization of formats common, and (3) high speed communication of data. The control system analysis tool 100, the motor electromagnetic field analysis tool 110 and the mechanism analysis tool 120 are above-described conventional software. The control system analysis tool 100 is Matlab/Simulink or similar software, the motor electromagnetic field analysis tool 110 is JAMG or similar software, and the mechanism analysis tool 120 is ADAMS or similar software.

For example, data is exchanged between Matlab/Simulink of the control system analysis tool 100 and JAMG of the motor electromagnetic field analysis tool 110; Matlab/Simulink of the control system analysis tool 100 and ADAMS of the mechanism analysis tool 120 of vehicle; and JMAG of the motor electromagnetic field analysis tool 110 and ADAMS of the mechanism analysis tool 120 of vehicle through Matlab/Simulink of the control system analysis tool 100, through the S-Function supplied by Matlab/Simulink of the control system analysis tool 100. A memory-resident region required for exchanging data of the interface 200 is secured by using WORK VECTOR supplied by Matlab/Simulink of the control system analysis tool 100, and the constituted interface software (S-Function) is converted to DLL (Dynamic Link Library). With this, speed of data exchange between the analysis tools can further be increased. Management of calculation state is executed by Matlab/Simulink. For example, proceeding of calculation steps are executed by Matlab/Simulink, and through the interface 200, calculation in each step is executed by JMAG and ADAMS. A result of calculation is mutually shared through the interface 200.

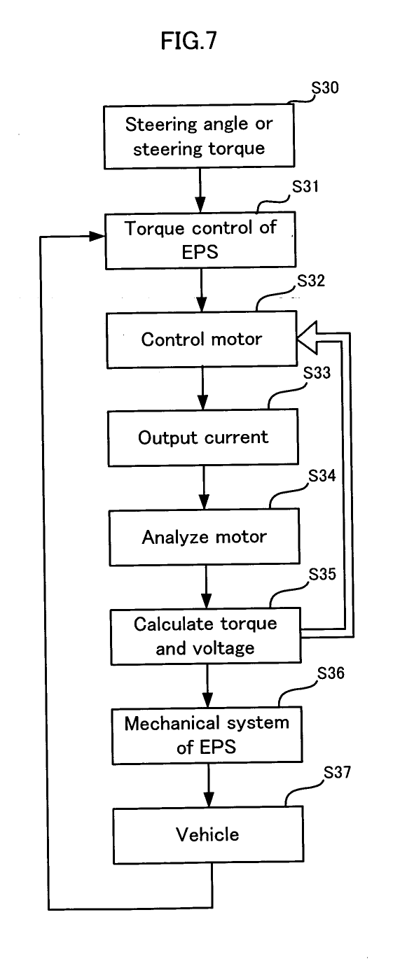

According to the present invention, as shown in FIG. 7, first, a steering angle (a steering torque) is given (step S30), a torque of the electric power steering apparatus is controlled (step S31), the motor is controlled (step S32), current output from the motor is detected (step S33), and the motor is analyzed based on the output (step S34). Torque and voltage are calculated by the motor analysis (step S35), and the torque and the voltage are fed back to the motor control. Then, the mechanical system of the electric power steering apparatus is driven (step S36), and the vehicle is allowed to run based on the output (step S37). Characteristics obtained by the running of the vehicle are fed back to the control of the electric power steering.

Step S34 (motor analysis) and step S35 (calculation of torque, voltage/current) are carried out by JMAG, step S36 (mechanical system of EPS) and step S37 (vehicle) are carried out by ADAMS, and other calculations are carried out by Matlab/Simulink. Data is exchanged among the three analysis tools through the interface 200.

In the above embodiment, Matlab/Simulink is used as the control system analysis tool 100, JAMG is used as the motor electromagnetic field analysis tool 110 and ADAMS is used as the mechanism analysis tool 120 of the vehicle. However, in the present invention, other software can also be used as the control system analysis tool 100, the motor electromagnetic field analysis tool 110, the mechanism analysis tool 120 of the vehicle.

### INDUSTRIAL APPLICABILITY

In the present invention, the interface is provided among general analysis tools, the analysis tools of components are integrated, discussion about optimization of analysis and design of system, verification and evaluation using a prototype, and evaluation from customers are carried out, further, evaluation results are fed back to discussion about optimization of re-analysis and re-design of system. Therefore, efficient and swift design environment can be realized. Before the sub-system of the product (ECU+motor+mechanism) and the vehicle are combined with each other, it is possible to easily carry out analysis for the sub-system of product and a vehicle system including the sub-system of product, discussion about the optimization of the designing operation, and previously evaluation of function, performance and the like.

Further, it is possible to integrally control “stop, turn, and run” of a vehicle.

1. An integrated design system of an electric power steering apparatus in which a steering assisting force is given to a steering mechanism based on a current control value calculated from a motor current value detected by a motor current detection means, and a steering auxiliary command value calculated by a calculation means based on a steering torque and a vehicle speed, comprising:
a simulation controller for connecting an analysis tool of control system, an analysis tool of motor electromagnetic field and an analysis tool of mechanism of vehicle through an interface, and carrying out integrated simulation of said electric power steering apparatus.

2. An integrated design system of an electric power steering apparatus according to claim 1, wherein said simulation controller controls and manages entire sequence by calling sub-routines through said interface.

3. An integrated design system of an electric power steering apparatus according to claim 1, wherein said simulation controller has a maneuver, a simulation, a data to be produced, and a function for storing a result in a readable common file.

4. An integrated design system of an electric power steering apparatus according to claim 1, wherein said interface converts formats of said analysis tool of control system, said analysis tool of motor electromagnetic field and said analysis tool of mechanism of vehicle into a same format.

5. An integrated design system of an electric power steering apparatus according to claim 4, wherein said interface converts files of said analysis tools into a readable common file, and produces an index array which explains a conversion sequence.

6. An integrated design system of an electric power steering apparatus according to claim 4, wherein said interface has functions of standardization of data definitions, standardization of formats, and high speed communication of data.
